(19) United States
(12) Patent Application Publication
(10) Pub. No.: US 2018/0225684 A1
(43) Pub. Date: Aug. 9, 2018

(54) STRATEGIC OPERATION OF VARIABLE GENERATION POWER PLANTS

(71) Applicant: General Electric Company, Schenectady, NY (US)

(72) Inventors: Saikat RAY MAJUMDER, Niskayuna, NY (US); Jason BATES, Glenville, NY (US); Sumit BOSE, Niskayuna, NY (US)

(21) Appl. No.: 15/424,259

(22) Filed: Feb. 3, 2017

(51) Int. Cl. G06Q 30/02; G06Q 40/04; G06Q 40/06; G06Q 50/06

(52) U.S. Cl. CPC G06Q 30/0202; G06Q 50/06; G06Q 40/06; G06Q 40/04

(57) ABSTRACT

A system for strategic operation of a variable generation power plant includes a computing device in communication with a data store including environmental data independent system operator rules, operator risk metrics, power storage systems, a maintenance schedule, and a capacity record. The computing device including a statistical modeling unit to generate a risk-to-revenue strategic bid estimate for successive time periods based on one or more factors accessible in the data store, a display device to display a graphical representation of the risk-to-revenue strategic bid estimate; and a control processor that analyzes the risk-to-revenue strategic bid estimate to schedule the daily operation of a power storage system and to identify one or more time periods of the successive time periods in which to perform a scheduled maintenance. A method and a non-transitory computer readable medium are also disclosed.

### BACKGROUND

Operators of variable generation power plants (e.g., having power sources of wind, solar, run-of-river hydroelectricity, tidal, wave, etc.) can be incentivized to participate in dynamic, day-ahead, power production markets due to the potential of increasing the plant's revenue. Due to inherent uncertainty in the plant's power generation forecast and in the energy markets, the plant operators need to determine an optimal bidding strategy to minimize risk and maximize revenue.

Failure to meet the plant's forecasted production, and its related breach of not providing the contracted (bid) power, can potentially result in imbalance penalties from the independent system operator (ISO). These imbalance penalties can be assessed for either under-, or over-, supplying the bid power.

Conventional approaches for participating in the dynamic, day-ahead marketplace do not provide consideration for risk tolerance of the operator. Also, conventional approaches do not analyze bidding strategies for determining scheduling of power plant maintenance operations to minimize impact on revenue generation.

### BRIEF DESCRIPTION OF THE DRAWINGS

FIG. 1 depicts a system for strategic operation of a variable generation power plant in accordance with embodiments;

FIG. 2 depicts a flowchart of a process for data preparation in accordance with embodiments;

FIG. 3 depicts a flowchart of a process for estimating energy price risks and expected price spreads in accordance with embodiments;

FIG. 4 depicts a flowchart of a process for developing a bidding strategy in accordance with embodiments; and

FIG. 5 depicts a flowchart of a process for allocating asset risk in accordance with embodiments.

### DETAILED DESCRIPTION

Embodying systems and methods determine an optimum bid price and quantity for every hour of the day conditional on the local weather forecast of the variable generation power plant. Embodying systems and methods incorporate the power plant operator's risk tolerance in generating these bids and production quantities. In accordance with embodiments, one or more risk profiles, and/or multiple risk metrics, can be considered in generating the optimum bidding strategy given the operator's risk tolerance and/or threshold. In accordance with embodiments, maintenance scheduling can be performed based on the generated bids. The maintenance can be scheduled to have minimum impact on the revenue generation of the variable power plant.

An embodying variable generation power plant can make use of a power storage system (e.g., battery storage, thermal storage, hydro-electric storage, etc.) to reduce variability in power output. Optimal scheduling and operation of variable generation power plant output can depend on the plant operator's market bidding strategy. In accordance with embodiments, power storage system scheduling and operation can be performed based on these generated bids. The storage of generated power into a power storage system can be scheduled based on a factor to minimize risk of failure to meet contracted bids, or to maximize revenue from bidding strategy.

Embodying systems and methods can incorporate ISO-specific penalty functions into the bid/quantity optimization. Embodying systems and methods can increase revenue and decrease risk by strategic operation of the variable generation power plant(s) by incorporating a variety of factors such as weather forecasts, risk tolerance, penalty functions, power storage system capacity and efficiency, and scheduled maintenance outages into the bidding strategy.

Embodying systems and methods implement a statistical modeling suite that can account for uncertainties in generation capacity and price forecasts to provide optimum bid quantities and prices subject to customer needs. These forecasts can be provided in hourly increments to account for changes in weather and electricity demand over the course of the day.

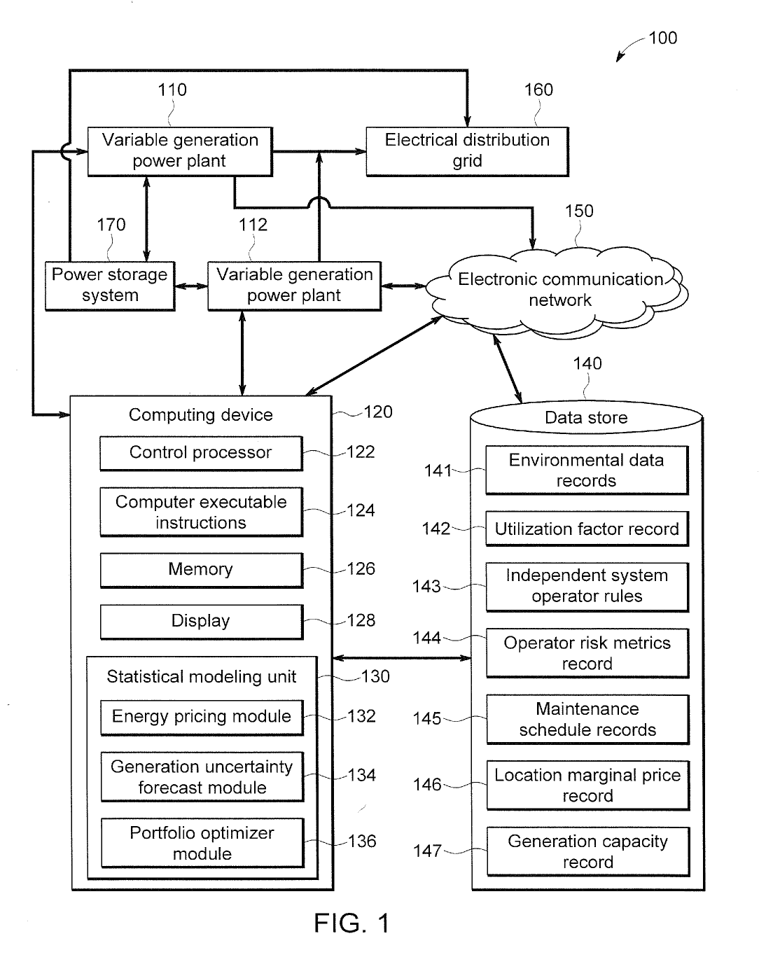

FIG. 1 depicts system 100 for strategic operation of a variable generation power plant in accordance with embodiments. The system can include one or more variable power generation plant(s) 110, 112. Each of the variable generation power plant can rely on a different, or the same, power source (e.g., wind, solar, run-of-river hydroelectricity, tidal, wave, etc.). The power generated by the variable generation power plant can be provided to electrical distribution grid 160, which can be operated by an ISO. The power generated by a variable generation plant can be stored in power storage system 170, from which the stored power can be later delivered to electrical distribution grid 160.

Computing device 120 can be in direct communication with one, or more, variable generation power plant(s), or in communication with the power plant(s) across electronic communication network 150. Computing device 120 can be of any type of computing device suitable for performance of the purpose disclosed herein (e.g., personal computer, workstation, thin client, netbook, notebook, tablet computer, mobile device, etc.). User computing device 120 can include control processor 122 that communicates with other components of the computing device across a data/communication bus. Control processor 122 accesses computer executable instructions 124, which can include an operating system, and software applications. The computer executable instructions can be stored in memory 126. The computing device can include display 128, and input devices such as touch screen, keyboard, mouse and the like (not shown). Data Store 140 can include data records 141, 142, 143, 144, 145, 146, 147 that are accessible by computing device 120 for read and/or write operations. Computing device 120 can be in bidirectional communication with other components of system 100 across electronic communication network 150.

Electronic communication network 150 can be, can comprise, or can be part of, a private internet protocol (IP) network, the Internet, an integrated services digital network (ISDN), frame relay connections, a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication means. It should be recognized that techniques and systems disclosed herein are not limited by the nature of network 150.

Computing device 120 can include statistical modeling unit 130, which can include three elements—energy pricing module 132; generation uncertainty forecast module 134; and portfolio optimizer module 136. In accordance with embodiments, statistical modeling unit 130 can optimize both bid price (revenue generation) and bid fraction (operator risk tolerance). Unlike conventional approaches, embodying systems and methods can produce an optimal strategy which maximizes revenue for a given risk. For example, the revenue and risk can be estimated for each hour of a day. The estimate can be based on environmental, market, operator risk tolerance/threshold, and other factors. Equation 1 can be used to perform the estimate:

Revenue=β*G_{F}*ΔP+G_{A}*P_{RT} EQ. 1

Where, β represents fraction of forecasted generation to be bid into day ahead market (bid fraction);

G_{F} represents megawatt hour generation forecast for the following day;

ΔP represents forecasted price difference between the real time and day ahead energy market;

G_{A} represents megawatt hour actual generation; and

P_{RT} represents real-time market for the following day.

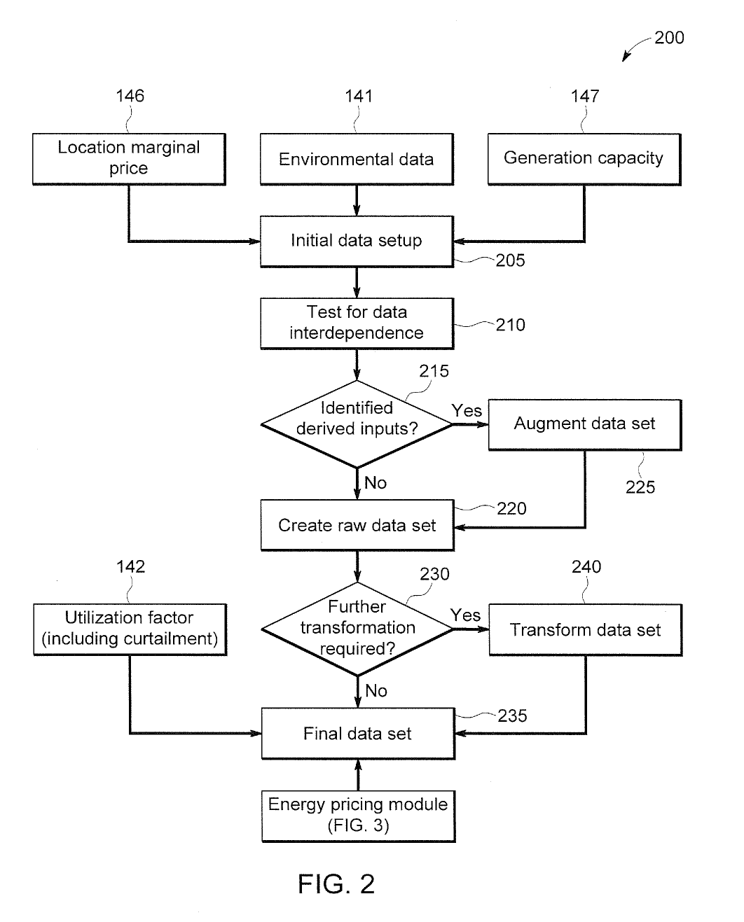

FIG. 2 depicts a flowchart of process 200 for data preparation in accordance with embodiments. An initial data setup is performed, step 205. This initial data setup includes obtaining location marginal price record 146, which is a specific cost set by the ISO associated with the connection node of electrical distribution grid 160 for a particular variable generation power plant under consideration. Also obtained are the actual generation capacity of the power plant under consideration, and environmental records 141 that can include temperature, wind forecast, tide forecast, and other weather variables pertinent to the particular primary power source of the variable generation power plant under consideration. This data can be collated into single data store, which can be accessed by statistical modeling unit 130.

After the initial data setup, the data is tested for interdependence, step 210. The interdependence of the data can correlate energy market prices with historical power generation, environmental data, etc. Based on interdependence of data, a determination is made identifying, step 215, derived inputs. Derived inputs can include time-lagged inputs, de-correlated inputs (principle components), imputed inputs to account for missing data, etc. If there are no derived inputs, a raw data set is created, step 220, from the initial data setup by retaining those elements which show relevance for predicting market prices. If there are derived inputs, then those inputs are added to the initial data setup to create an augmented data set, step 225. Then the raw data set is created at step 220, from the augmented data set by retaining those elements which show relevance for predicting market prices.

The raw data is checked, step 230, to determine whether further transformation of the data set is required, based on the requirements of the energy pricing module 132. If there no further data transformation is required, a final data set is created, step 235. If further data transformation is required, then the data set is transformed, step 240, before creation of the final data set. Transformation of the data set can include, but is not limited to, adjusting inputs based on empirical or non-empirical mathematical transforms (including, but not limited to, interpolations, log transforms, moving averages, etc.). The final data set can incorporate utilization rate factors 142 for the variable generation power plant, which can include curtailment restrictions correlated to particular times of day. This final data set is provided to energy pricing module 132.

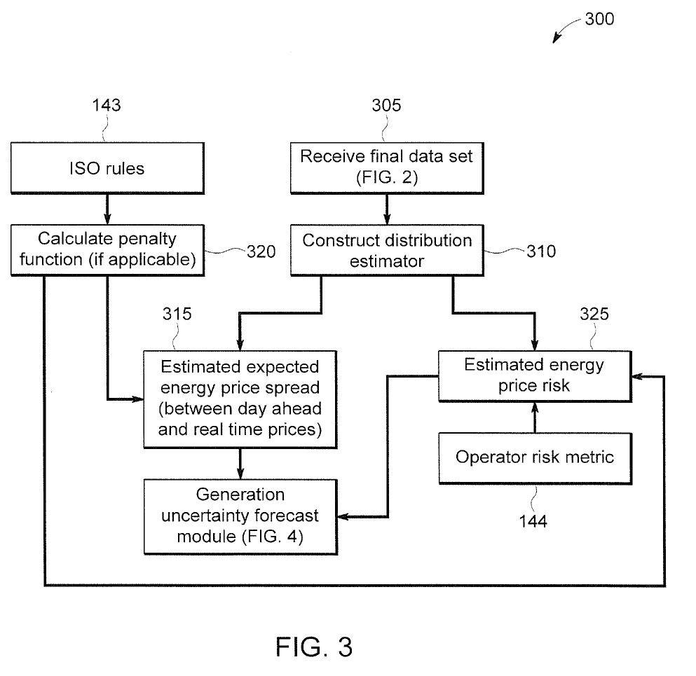

FIG. 3 depicts a flowchart of process 300 for estimating energy price risks and expected price spreads in accordance with embodiments. Energy pricing module 132 can use density estimation techniques (e.g., mixture modeling and Gaussian copulas) to produce an estimate of the statistical distribution of day-ahead market versus real-time market energy prices in order to compute the expected return per megawatt-hour (MWh) for a given bidding strategy. This allows the operator to select an optimum strategy (including bid price and bid quantity), based on their risk tolerance, to use for bidding into the day-ahead market (as opposed to selling into the real-time market at that same future time period).

The final data set (FIG. 2) is received, step 305, by energy pricing module 132. A distribution estimator function is constructed, step 310. This distribution estimator can use density estimation techniques to provide the estimated statistical distribution between day-ahead market versus real-time market energy prices.

An estimated expected energy price spread indicating the difference between the day-ahead and real-time markets can be estimated, step 315 (i.e., ΔP=P_{DA}−P_{RT}). In some implementations, this estimated expected energy price spread can include the impact from ISO rules 143. In some cases, the ISO rules can include a penalty function which is calculated, step 320, and incorporated into the expected price spread estimate. The estimated expected price spread is provided to generation uncertainty forecast module 134.

An energy pricing model can be used to estimate, step 325, an energy price risk factor. The model can incorporate computation of statistical distribution of expected energy price spread as a function of predictor variables: P[ΔP|X₁, X₂, . . . , X_{N}]. Predictor variables can include, but are not limited to, forecasted weather data, historical price data, time-of-day, etc. In accordance with embodiments, the energy pricing estimate can be informed by operator risk metric 144 conditions. Operator risk metrics can be chosen by the operator from a range of risk estimation techniques, including but not limited to Expected Shortfall (ES), Value-at-Risk (VaR), or variance. This energy price risk estimate is also provided to generation uncertainty forecast module 134. The energy pricing estimate can also account for maintenance scheduling parameters stored in maintenance scheduling record 145.

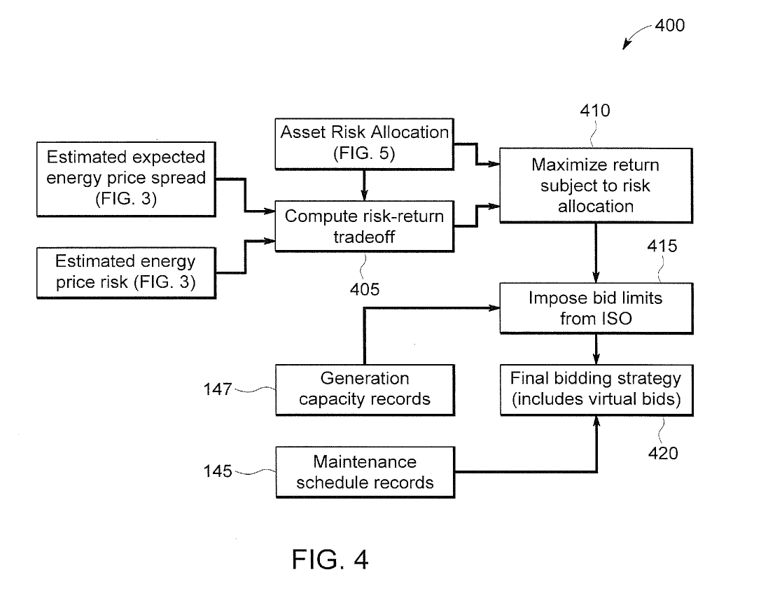

FIG. 4 depicts a flowchart of process 400 for developing a bidding strategy in accordance with embodiments. Generation uncertainty forecast module 134 can use pricing data output (i.e., estimated expected energy price spread 315 and estimated energy price risk 325) from energy pricing module 132. The bidding strategy can incorporate a statistical estimation of the variance in the generation forecast and a Monte Carlo simulation to develop the risk estimate associated with a given bidding strategy. This allows variable generators to select the optimum quantity to bid into the day-ahead market to maximize revenue while minimizing risk.

To arrive at the bidding strategy, the generation uncertainty forecast module implements equation 2, which using risk assessment results can find a value for bid fraction β which maximizes return subject to market and risk constraints:

Market: 0≤β≤1.2

Risk: βG_{F}*Risk[ΔP]≤α

$$β = \{ \begin{matrix}0 , & E [ Δ P ] \leq 0 \\ \frac{α}{{G}_{F} * {ES}_{τ} [ Δ P ]} , & 0 \leq \frac{α}{β {G}_{F} * Risk [ Δ P ]} \leq 1 \\ 1 , & \frac{α}{β {G}_{F} * Risk [ Δ P ]} > 1\end{matrix} \qquad EQ . 2$$

Where, β represents bid fraction;

G_{F} represents generation forecast;

E[ΔP] represents expected price difference;

Risk[ΔP] represents expected risk;

α represents the operator input risk tolerance; and

ΔP represents price difference.

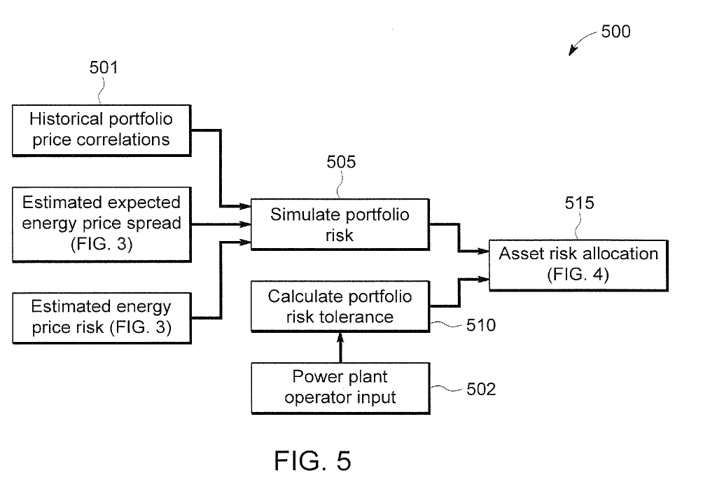

A risk-return tradeoff is computed, step 405. This tradeoff is based on the estimated expected energy price spread and the energy price risk provided by energy pricing module 132 (FIG. 3). The tradeoff can also include an asset risk allocation provided by portfolio optimizer module 135 (FIG. 5). A maximized return subject to the risk allocation is calculated, step 410. This maximized return can include imposition of bid limits, step 415, from the ISO. The maximized return can also take into consideration generation capacity records 147 of the specific variable generation power plant.

In accordance with embodiments, the final bidding strategy, step 420, can include virtual bids. The bidding strategy can represent each segment of a 24 hour period and include a quantity for day-ahead bidding and a quantity for real time alternatives.

FIG. 5 depicts a flowchart of process 500 for allocating asset risk in accordance with embodiments. Portfolio optimizer module 136 can use the output of energy pricing module 132 (i.e., estimated expected energy price spread 315 and estimate energy price risk 325) in combination with generation uncertainty forecast module 134 to construct an estimate of the overall risk/return curve for a variable generator across a full day of bidding. In accordance with embodiments, for power plant operators with more than one site or generation asset, an overall risk/return curve can address multiple sites/generation assets. The risk/return curve can provide the power plant operator to arrive at bidding strategy that is optimized for maximize revenue subject to their daily total risk tolerance. The portfolio optimizer module can develop a risk/return curve that proportionally allocates more risk to sites and/or hours of the day where the risk/return curve is favorable, and proportionally less risk to sites and/or hours of the day where the risk/return curve is less favorable.

The portfolio risk is simulated, step 505, by the portfolio optimizer module. Risk simulation can be based on historical portfolio price correlations 501, the estimated expected energy price spread 315, and the estimated energy price risk 325. A portfolio risk tolerance can be calculated, step 510, using power plant operator input 502 that can include the operator's hourly risk tolerance a, and other factors (e.g., operator risk metrics record 144). The risk/return curve can be calculated from equation 3 and equation 4:

Daily Return=Σᵢ₌₁²⁴(βᵢG_{F,i}*E[ΔPᵢ]+E[G_{A,i}P_{RT,i}]) EQ. 3

Daily Risk=(Σᵢ₌₁²⁴(βᵢG_{F,i}*Risk[ΔPᵢ])^{γ})^{1/γ} EQ. 4

Where, i=1, . . . , 24 represents hour of the day;

βᵢ represents bid fraction at hour i;

G_{F,i} represents generation forecast at hour i;

E[ΔPᵢ] represents expected price difference at hour i;

P_{RT,i} represents forecasted real-time market price at hour i;

Risk[ΔPᵢ] represents forecasted risk at hour i;

and γ is a factor whose value depends on the auto-correlation of ΔP.

The simulated portfolio risk and the operator-provided risk tolerance(s) can be provided to generation uncertainty forecast module 134 as input to develop the bidding strategy as disclosed above.

In accordance with embodiments, an enterprise can provide embodying methods as a software service to operators of variable generation power plants. Embodying systems and methods provide an ability to estimate profitability for potential installation sites based on environmental factors, and other information, for the potential site.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for determining strategic operation of a variable generation power plant, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A system for determining strategic operation of a variable generation power plant, the system comprising:
a computing device having a control processor, the control processor configured to execute computer executable instructions;
a data store in communication with the computing device, the data store including at least one of an environmental data record, one or more independent system operator rules, an operator risk metric record, a maintenance schedule record, and a generation capacity record;
the computing device including a statistical modeling unit configured to generate a risk-to-revenue strategic bid estimate for successive time periods;
the risk-to-revenue strategic bid estimate based on one or more of factors including an environmental factor, an operator risk tolerance/threshold factor, a power storage scheduling factor, and a maintenance scheduling factor;
a display device in the computing device configured to display a graphical representation of the risk-to-revenue strategic bid estimate; and
the control processor configured to execute computer executable instructions that cause the control processor to analyze the risk-to-revenue strategic bid estimate to identify one or more time periods of the successive time periods in which to perform at least one of schedule an operation of a power storage system and a scheduled maintenance.

2. The system of claim 1, the control processor identifying the one or more time periods based on a minimum impact on revenue generation of the variable generation power plant.

3. The system of claim 1, the control processor configured to display the one or more time periods on the display device.

4. The system of claim 1, the statistical modeling unit including an energy pricing module, a generation uncertainty forecast module and a portfolio optimizer module.

5. The system of claim 4, the energy pricing module configured to estimate an energy price risk and estimate an expected energy price spread.

6. The system of claim 5, the estimate of the energy price risk informed with one or more operation risk metric conditions, and the estimate of expected energy price spread informed with an impact from one or more independent service operator rules.

7. The system of claim 4, the generation uncertainty forecast module configured to include in the risk-to-revenue strategic bid estimates at least one of an energy price risk estimate, an expected energy price spread estimate, a statistical estimation of a variance in power generation by at least one variable generation power plant, and a portfolio risk allocation.

8. The system of claim 4, the portfolio optimizer module configured to generate a portfolio risk allocation, the portfolio risk allocation including at least one of an energy price risk estimate, an expected energy price spread estimate, a portfolio price correlation factor, and one or more power plant operator risk input factors.

9. A method for determining strategic operation of a variable generation power plant, the method comprising:
accessing in a data store at least one of an environmental data record, one or more independent system operator rules, an operator risk metric record, a maintenance schedule record, and a generation capacity record;
estimating a risk-to-revenue strategic bid for successive time periods, the risk-to-revenue strategic bid incorporating on one or more factors including an environmental factor, an operator risk tolerance/threshold factor, and a maintenance scheduling factor, each factor accessed from a respective record of the data store;
displaying a graphical representation of the risk-to-revenue strategic bid estimate;
analyzing the risk-to-revenue strategic bid estimate to schedule an operation of a power storage system; and
analyzing the risk-to-revenue strategic bid estimate to identify one or more time periods of the successive time periods in which to perform a scheduled maintenance.

10. The method of claim 9, including identifying the one or more time periods based on a minimum impact on revenue generation of the variable generation power plant.

11. The method of claim 9, including displaying the one or more time periods on the display device.

12. The method of claim 9, the estimating the risk-to-revenue strategic bid including estimating an energy price risk and estimating an expected energy price spread.

13. The method of claim 12, informing the estimate of the energy price risk with one or more operation risk metric conditions, and informing the estimate of expected energy price with an impact from one or more independent service operator rules.

14. The method of claim 9, including in the risk-to-revenue strategic bid estimate at least one of an energy price risk estimate, an expected energy price spread estimate, a statistical estimation of a variance in power generation by at least one variable generation power plant, and a portfolio risk allocation.

15. The system of claim 9, including generating a portfolio risk allocation, the portfolio risk allocation including at least one of an energy price risk estimate, an expected energy price spread estimate, a portfolio price correlation factor, and one or more power plant operator risk input factors.

16. A non-transitory computer readable medium containing computer-readable instructions stored therein for causing a control processor to perform a method for determining strategic operation of a variable generation power plant, the method comprising:
accessing in a data store at least one of an environmental data record, one or more independent system operator rules, an operator risk metric record, a maintenance schedule record, and a generation capacity record;
estimating a risk-to-revenue strategic bid for successive time periods, the risk-to-revenue strategic bid incorporating one or more factors including an environmental factor, an operator risk tolerance/threshold factor, and a maintenance scheduling factor, each factor accessed from a respective record of the data store;
displaying a graphical representation of the risk-to-revenue strategic bid estimate; and
analyzing the risk-to-revenue strategic bid estimate to identify one or more time periods of the successive time periods in which to perform at least one of schedule an operation of a power storage system and a scheduled maintenance.

17. The non-transitory computer readable medium of claim 16 containing computer-readable instructions stored therein to cause the control processor to perform the method, including:
identifying the one or more time periods based on a minimum impact on revenue generation of the variable generation power plant; and
displaying the one or more time periods on the display device.

18. The non-transitory computer readable medium of claim 16 containing computer-readable instructions stored therein to cause the control processor to perform the method, including:
estimating the risk-to-revenue strategic bid including estimating an energy price risk and estimating an expected energy price spread;
informing the estimate of the energy price risk with one or more operation risk metric conditions; and
informing the estimate of expected energy price with an impact from one or more independent service operator rules.

19. The non-transitory computer readable medium of claim 16 containing computer-readable instructions stored therein to cause the control processor to perform the method, including:
in the risk-to-revenue strategic bid estimate including at least one of an energy price risk estimate, an expected energy price spread estimate, a statistical estimation of a variance in power generation by at least one variable generation power plant, and a portfolio risk allocation; and
generating a portfolio risk allocation, the portfolio risk allocation including at least one of the energy price risk estimate, the expected energy price spread estimate, a portfolio price correlation factor, and one or more power plant operator risk input factors.
